(19) United States
(12) Patent Application Publication
(10) Pub. No.: US 2001/0034845 A1
(43) Pub. Date: Oct. 25, 2001

(54) Secure web-based document control process and system

(76) Inventors: George B. Brunt, Plano, TX (US); John J. Kendrick JR., Dallas, TX (US); Robert N. Higbee, Plano, TX (US)

Correspondence Address: Timothy F. Loomis, Law Offices of Timothy F. Loomis, 2932 Hagen Drive, Plano, TX, 75025, US

(21) Appl. No.: 09/783,161

(22) Filed: Feb. 14, 2001

Related U.S. Application Data
(60) Provisional application No. 60/182,536, filed on Feb. 15, 2000.

(51) Int. Cl. H04L 9/32; H04L 9/00; G06F 12/14

(52) U.S. Cl. 713/201; 709/217; 713/189

(57) ABSTRACT

A secure Internet-accessible document control system and method that facilitates the secure storage of documents on a computer system and permits selected authorized users to access the stored documents through the Internet from remote locations. The document control system and method being particularly well suited for litigation management in cases where a plurality of confidentiality levels govern access to the documents.

### CROSS-REFERENCE TO RELATED APPLICATION

This application arises from provisional application No. 60/182,536 filed on Feb. 15, 2000 and claims benefit of that filing date.

### FIELD OF THE INVENTION

This invention relates to providing a secure Internet-accessible document control system and method that facilitates the secure storage of documents on a computer system and permits authorized users to access the stored documents through the Internet from remote locations.

### BACKGROUND OF THE INVENTION

In the past, many document storage and access systems have been relegated to the paper world due to the fact that most corporate documents exist in paper copy. Handling such documents, especially when multiple reproductions of large volumes of the documents are required, has been a labor-intensive effort. For example, when a company is a party to litigation, it normally must produce corporate documents that are related to issues in the litigation when so requested by the opposing party. Usually, the documents produced have to be photocopied numerous times so that a pristine set and a work set of the documents can exist at each of the attorneys' offices for both parties to the litigation. Should the litigation be a large business case, it is not uncommon to have millions of pages of documents produced.

In such a litigation, each party generally has its legal team review the documents it is producing and those produced by the other party to find documents that might be useful in the case. When the volume of documents is so large, a system needs to be in place to actually be able to find and use such documents when a need arises, such as in preparation for a deposition. One such system involves each party to the litigation studying each of the documents and compiling an index or summary containing pertinent information on that document. Then when a need arises, such as in preparing for a deposition, the legal team could perform a review of the indexes or summaries, instead of studying all of the documents again. Although this saves some time, it is still very labor intensive. Additionally, the reliance on the indexes is not a good situation as the indexes are subject to human error in their initial composition.

A related method uses to manage litigation documents is to have the indexes and/or summaries created electronically so they can be searched electronically. This improves the time required to find documents to be used in a deposition, for example. However, this system is still at the mercy of human errors made during the creation of the indexes or summaries.

Yet another method used in litigation is to pare down the size of the set of documents during the initial review of the document set. This process creates a smaller set of core documents. Under this method, those documents believed to be most important to the case are set aside and looked through in preparation for a deposition, for example, while the other documents are ignored. This method does not do away with the human error problem because the initial review may incorrectly leave documents out of the core set. Additionally, when new issues arise in the litigation, for example after the filing of an amended pleading adding a new claim or counterclaim, the core set of selected documents may not include documents related to the new claim. The team would then have to go back through all the other documents to find those related to the new claim.

Another existing method of dealing with the document problem is to scan in the documents into a computer system and to burn images of the documents onto a storage medium, such as a CD-ROM. This drastically reduces the volume of space taken up by the documents. The documents can also be run through an optical character recognition (OCR) system to create a searchable electronic document roughly corresponding to the optical image of the document. Such electronic images can be searched during preparation for a deposition, for example, through a system such as Concordance. While this system has advantages over the other prior art systems mentioned above, in that the OCR documents can be electronically searched for terms, it does have drawbacks.

Many times, during large litigation where legal team members, experts and employees of a party may be exposed to highly sensitive internal information of its opposing party, a protective order is put into place to govern who can see what documents. These protective orders usually state that certain people or types of people can see certain classes of documents. For instance and merely as an example, a protective order may state that lawyers and staff may see documents designated as “attorney's eyes only”; a limited number of people assisting in the litigation that are employees of a party may see documents designated as “highly confidential”; and another limited number of people that are assisting in the litigation and are employees of a party may see documents designated as “confidential”. Such protective orders normally contain provisions permitting correction of misdesignated documents or challenging of believed misdesignated documents.

When the CD-ROMs are burned, the documents may be arranged so that certain disks contain no documents of a higher designation, so that people that can see documents at the “confidential” level, will not have disks containing “attorney's eyes only” documents or “highly confidential” documents. If many people are involved in the litigation and need access to the documents, numerous sets of the CD-ROMs may be made and distributed to the various individuals.

In large litigation, errors in the designation of documents is a fairly frequent occurrence. If the producing party redesignates a document to a higher level, for instance from “confidential” to “highly confidential”, a problem arises with the CD-ROM system. Usually, the protective order in a case requires documents to be labeled with their confidentiality level. Thus, all the CD-ROMs containing that document would have to be reburned to include the new confidentiality level designation. Additionally, all of the people that are permitted to see “confidential” documents, but not higher security level documents now need to have their CD-ROMs reburned to exclude the mislabeled document. Changes may also have to be made to the corresponding OCR document.

Another similar problem occurs if documents have been produced erroneously that are subject to a legal privilege, such as the attorney-client privilege. During large litigation it is rare that some privileged documents are not produced erroneously. Protective orders normally give the parties the opportunity to demand return or destruction of all such documents. If such documents are burned into a CD-ROM, the CD-ROM itself must be returned or destroyed and a new CD-ROM must be created so as to exclude those documents.

Another prior art system that could be used is shown in FIG. 1 (Prior Art). Under this prior art system, users 1-1 through 1-x may search for documents stored on CD-ROMs 30-1 through 30-x residing on CD-ROM carousel 20 through a computer network and server 10. This system permits different lawyers within a law firm to perform searches at the same time while only using one set of the CD-ROMs 30-1 through 30-x. However, problems with this system exist as well. If someone is searching CD-ROM 30-1, CD-ROM 30-x may not be available to search because CD-ROM 30-1 is currently being read in the carousel 20. Thus, a price in efficiency is paid for the cost savings gained by not making multiple CD-ROMs. An alternative would be to utilize a database rather than CD-ROM carousel 20 which may improve efficiency.

Additionally, this prior art system does not address the different confidentiality levels on different documents imposed by the protective order because the attorneys and staff at law firms which may utilize such a system normally can access all of the documents produced in the litigation. So a person with limited access rights, such as one who can only access “confidential” documents, cannot use the system.

Moreover, none of the aforementioned prior art systems address the problem encountered when an attorney is traveling to take a deposition. That attorney must either carry the documents he or she is planning on using in the deposition with them or a set of CD-ROMs containing those documents. This can be quite bulky. Additionally, in the event that the witness being deposed mentions a document that has been produced, but that the attorney has not brought with him, the attorney must have someone back at the office look for it. If that lawyer is lucky, that person back at the office will be able to find it prior to the end of the deposition and fax it to him.

### SUMMARY OF THE INVENTION

An embodiment of the present invention provides a secure Internet-accessible document control system that permits the secure storage of documents on a computer system and permits authorized users to access the stored documents stored through the Internet from remote locations.

Another embodiment of the present invention provides a secure Internet-accessible litigation assistance system that permits the secure storage of litigation related documents of varying confidentiality levels on a computer system and permits authorized users to access the stored documents of an authorized confidentiality level stored through the Internet from remote locations.

Yet another embodiment of the present invention provides a provides a secure Internet-accessible litigation assistance system that permits the secure storage of documents and comments or annotations relating to the documents on a computer system and permits authorized users to access documents of an authorized confidentiality level through the Internet from remote locations and to record comments or annotations relating to such documents.

As such, it is an object of the present invention to permit authorized users to securely access documents stored on a computer system through the Internet from remote locations.

It is a further object of the present invention to permit authorized users to securely access authorized litigation documents of varying confidentiality levels stored on a computer system through the Internet from remote locations.

It is yet a further object of the present invention to permit authorized users to securely access authorized litigation documents of varying confidentiality levels and comments or annotations stored on a computer system through the Internet from remote locations and to record comments or annotations of their own.

### BRIEF DESCRIPTION OF THE DRAWINGS

FIG. 1 (Prior Art) is a block diagram of a litigation document system according to the prior art.

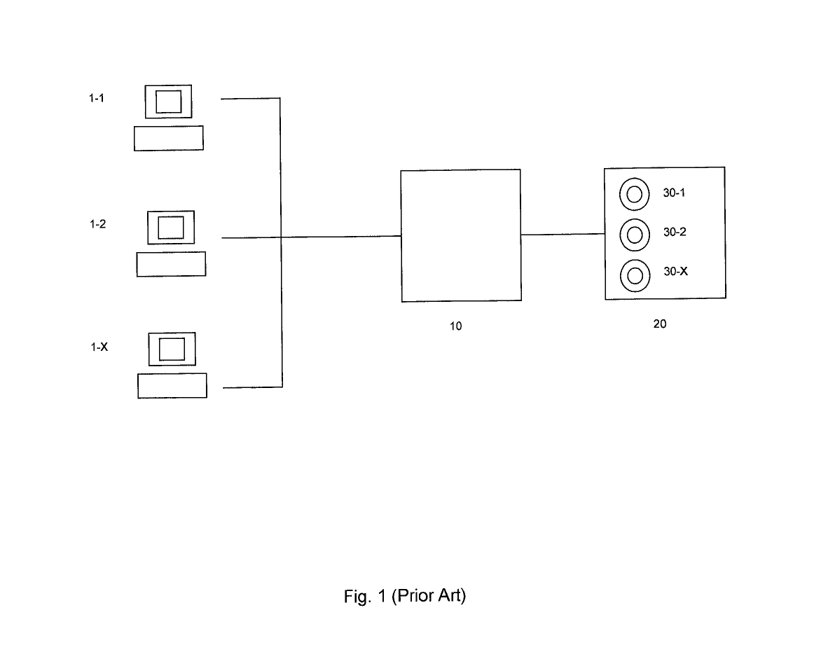

FIG. 2 is a block diagram of a secure document system permitting remote users to access documents stored thereon according to an embodiment of the present invention.

FIG. 3 is a flow chart showing the process of a user accessing documents from a secure site according to an embodiment of the present invention.

FIG. 4 is a flow chart showing the process undertaken to permit the access of documents securely through the system according to an embodiment of the present invention.

FIG. 5 is a flow chart showing the process of producing documents according to an embodiment of the present invention.

### DESCRIPTION OF THE PREFERRED EMBODIMENTS

The present invention will be better understood by reference to the accompanying drawings.

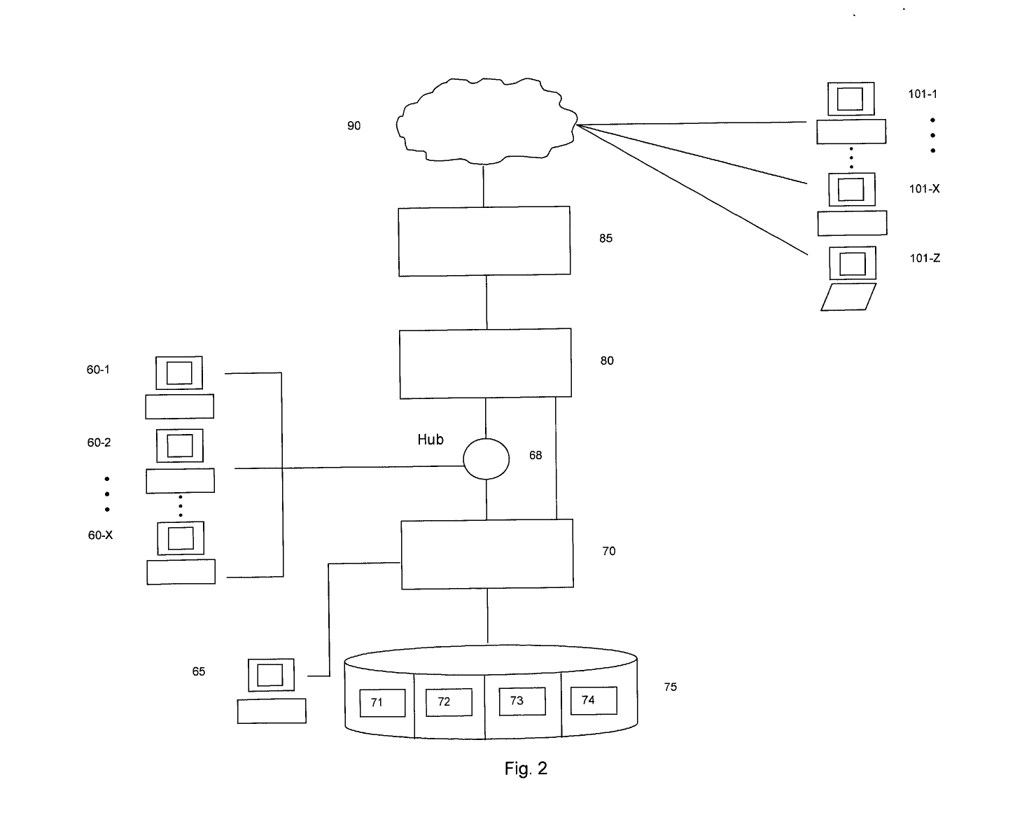

An embodiment of the present invention is depicted in FIG. 2. Referring to that figure, a database 75 for storing document images, document indexes and/or summaries (for simplicity purposes, the term index as used hereinafter shall mean index and/or summary), OCR records of documents and notes is provided. Preferably, the database is a RAID array. Alternatively, multiple separate databases or other electronic storage media could be used.

Document management service 70 is connected to database 75. Document management service 70 provides the interface between the database and the outside world. It provides the search capabilities and note making capabilities to users. Document management service 70 includes capabilities such as those provided by discovery management software commercially available from Precise Systems Corporation, including document collection, database creation, and indexing of documents.

Managers can be connected to the document management service 70, such as manager 65. Manager 65 can provide management functions, such as password assignment for authorized users, account management, other security functions and database administration.

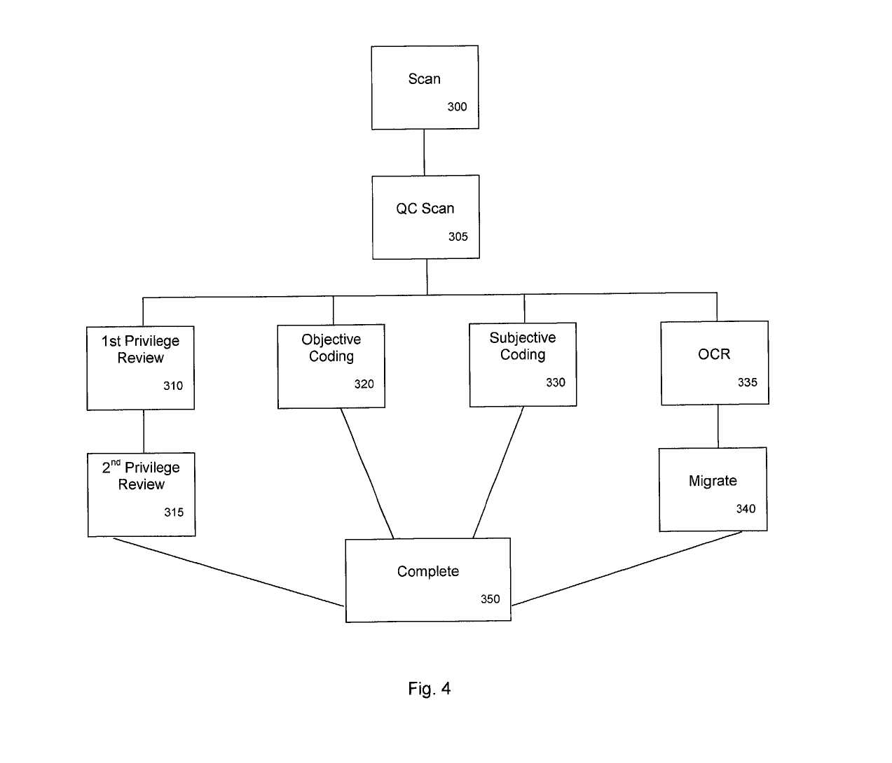

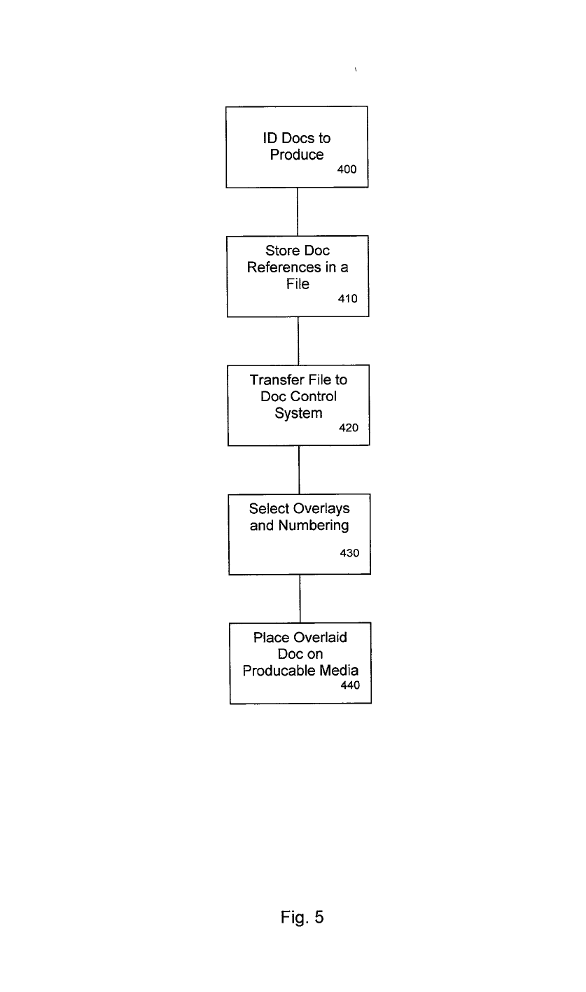

Document management service 70 may also be connected to a hub 68 for providing access to the service for document workers 60-1 through 60-x. This permits document workers 60-1 through 60-x to scan, code and store the documents in database 75. This process will be discussed more thoroughly with regards to FIG. 4. When production of documents is to occur, document workers 60-1 through 60-x can produce the documents from the document management service 70 and the database 75. This process will be discussed more thoroughly in regards to FIG. 5.

Hub 68 and document management service 70 can be connected to a web server and firewall 80 for providing secure access to the Internet 90. As used herein, the Internet shall encompass not only the present day Internet, but any future network that provides the broad connectivity that the Internet currently does. A router 85 may be included for connection to Internet 90. By connecting hub 68 to the Internet 90, access is provided for document workers 60-1 through 60-x to the Internet 90 so that they may communicate with users should questions arise regarding the encoding, storing or production processes occur. Alternatively, if this arrangement causes security concerns, hub 68 could not be attached to webserver and firewall 80. Under this alternative arrangement, document workers 60-1 through 60-x would be forced to go through document control service 70 to access the Internet.

Users 101-1 through 101-x have access to the documents stored in database 75 through the Internet 90. Preferably, users 101-1 through 101-x would be permitted to access the images of documents created through the scanning process, such as image 71; through a search of indexes, such as index 72; or through a search of OCR files representing documents, such as OCR file 73. Again, document management service 70 would provide the search functions. Additionally, notes could be placed and viewed by a user, such as notes 74. Preferably, notes 74 would be associated with image 71 so that a user could selectively change between viewing image 71 and notes 74. Also, preferably, notes 74 would be associated with image 71 in such a way that they would appear to user to be the image 71 with certain text highlighted and/or with sticky pad notes attached. The highlighting could be, for instance, a contrasting color overlaid on the document, different colored text, boxed or circled text, bolded text, underlined text, italicized text, or the like.

User 101-z, a user operating a laptop from a location remote from his office and from the document storage area, is also connected through the Internet 90 to the document management service 70 and database 75. Preferably, user 101-z interoperates with the central document storage area just as users 101-1 through 101-x, so that when a user that normally accesses the documents through a fixed location has to travel and needs to access the documents, the procedure he has to undertake is the same.

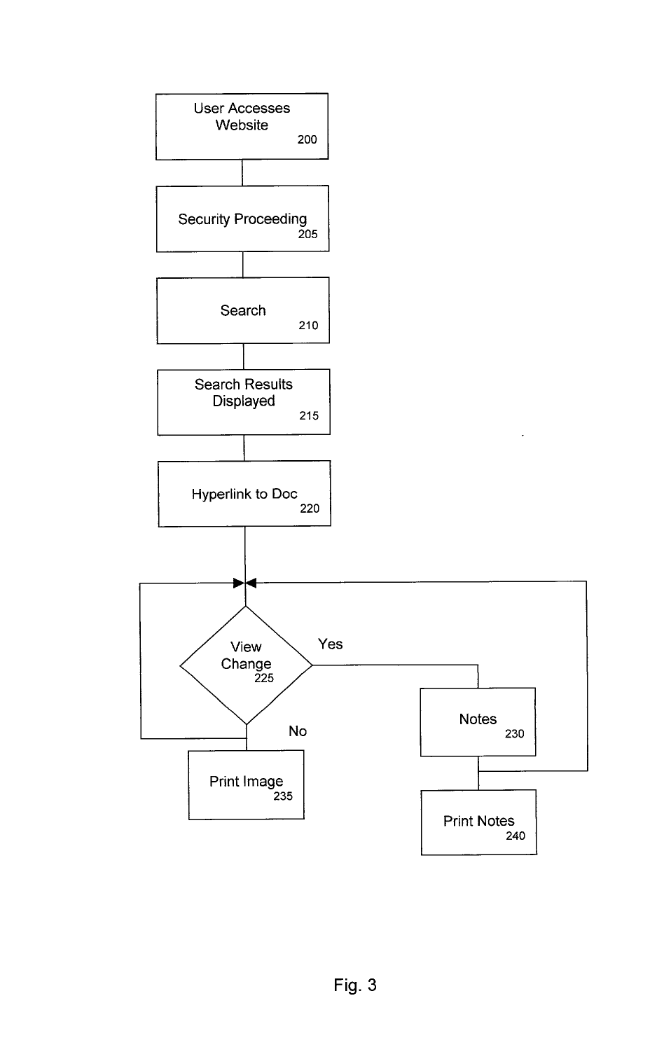

In FIG. 3, a flow chart showing the process of accessing documents through a system according to an embodiment of the present invention is shown. In step 200, a user, such as an attorney working on a particular litigation, accesses the website of the centralized document storage facility through the Internet. By having the website accessible via the Internet, users working on fixed sites, such as users 101-1 through 101-x can have access to the documents stored therein, as well as users who are traveling, for example to take a deposition, such as user 101-z.

After the user accesses the website, in step 205 security procedures are engaged in order to permit the user to access the documents the user is actually permitted to see with database 75. Preferably, the security procedures include requiring the user to log on to the secure portion of the website, prior to gaining access to the document management system 70. Preferably, the user will be required to enter a unique user ID and password and further transmission of information between the user and the central document storage system will be encrypted. Thus, any information intercepted by a third party will be unintelligible. This is important because of the strong security interests parties involved in litigation usually have regarding their internal business documents. The user ID and password could be stored in the user's computer, so that the user does not need to reenter it every time he logs in or he could be required to enter them each time, depending on the security concerns of the clients. The user ID and password should sufficiently identify the user so that access can be granted only to portions of the database 75 to which that user has been cleared to see. User ID, password and encryption software are currently widely available and such software could be integrated into web server and firewall 80 and/or document management service 70 to address the security concerns.

Once access to the secure portion of the website is accomplished, a search page is displayed in step 210, enabling the user to search a selected database or group of documents for specific information. For example, user 1011 could enter a search term of “Robert Smith” from the search group of “letters” to search for letters that mention Mr. Smith. Many search engines are currently commercially available that can be integrated into document management service 70 to handle the search functions.

In step 215, the results of the search are displayed, preferably as a list of hyperlinks. In the example listed above, for instance, five letters written by Mr. Smith, three letters to Mr. Smith and 2 letters that mention Mr. Smith could be listed. If the user were to click on one of the an item in the list, he should then be shown the image of the corresponding document stored on database 75, as noted in step 220. Preferably, any attachments to the document would be available to the user through hyperlinks displayed along with the image of the document.

When shown the image of the document, the user should be able to magnify the document and rotate the document to improve legibility. Software permitting such manipulation of documents is currently commercially available. Also, the user should be able to change the view as shown in step 225 to display any notes and/or the index listing the document being viewed. Preferably, the notes view as mentioned in step 230 would look like the image but with notes superimposed upon the image, so that highlighting could be added. The notes, for instance, could appear similar to sticky notes. The user should be able to add to the notes and/or amend the notes as well.

The user is also permitted to print the image in step 235 or the notes and/or indexed information in step 240. Preferably, this would print the entire selected document (not just the page being viewed) locally at the user location. Thus, if a user were away from his office preparing for a deposition, he could easily print copies of the documents he may want to use in that deposition. If desired, the logic flow can be arranged differently than is shown in FIG. 3. For example, a user could be able to print the image while viewing the notes and/or index or print the notes and/or indexed information while viewing the image.

In FIG. 4, the process by which the centralized document storage facility handles the documents provided to it is shown. In step 300, the documents provided to the facility in paper form are scanned into an electronic database and assigned a unique document ID, such as a number or file name. In step 305, the scanning job is subjected to quality control to ensure that all the documents have been successfully scanned into database 75. In step 310, personnel with legal backgrounds review the documents to determine if any of the documents are subject to various privileges such as the attorney-client privilege. This review can be done from the paper documents or from the scanned images. In step 315 the documents can be reviewed again to ensure that privileged documents are not missed. Any documents found to be subject to privilege will not be produced, but instead be listed on a privilege log. If at a later time a document is found to be privileged that was missed originally, it could be added to the privilege log and removed from the group of produced documents.

In step 320, the documents are subjected to objective coding. In this step, people review the documents and create index information relating to objective features of the document, such as date, type of document (for example, a letter, a memo, etc.), author, recipient, etc. In step 330, the documents can be subjectively coded. In this step, people more closely associated with the issues in the litigation view documents to see if they are related to any issues in the case and that information is put in an index.

In step 335, the documents are run through an OCR process to create files that represent electronically searchable versions of the scanned optical images of the documents. Since OCR technology is not 100% reliable, if desired, a person could review all or some of the documents and compare them to the OCR files to determine if the OCR process is correct. If mistakes are discovered, that person can correct the mistakes.

In step 340, the OCR files are migrated to the database 75. Once all of the above mentioned steps have been finished, the process is completed (step 350). Preferably, at some point during the process, the index, document image and OCR file corresponding to each document are associated to each other so that a search that results in a hit on an index or OCR file will permit the user to view the associated document image.

Although many of the steps in FIG. 4 are shown as occurring in parallel, they may be executed in series or in a mixture thereof.

In FIG. 5, the process of producing documents to an opposing party in litigation using a system according to an embodiment of the present invention is described. Since all the documents being placed onto the system have already been scanned into the system and images of the documents reside on the system, they can be quickly produced to the opposing party without having to remove staples a second time from the documents and place each document into a copy machine.

In step 400, a person selects those documents that should be produced from the documents that have been scanned into the system. These documents would exclude any of those found in steps 310 and 315 as being privileged.

In step 410, the person stores a list of the documents (by file name, for instance) or the documents themselves in a file. This file is then transferred to the document control system 70 in step 420.

In step 430, a person then selects overlays to be used with the images. The overlay can display a confidentiality label for the document. The person also selects a numbering scheme to be used with the overlay so that every page of every document is labeled with a number uniquely identifying that page. This is sometimes referred to as a Bates number. Overlay software is currently commercially available.

In step 440, the document control system 70 takes the file transferred in step 420 and processes it so as to place the images of the selected documents with the confidentiality level designation and Bates numbers in place onto media that can be produced to the opposing party. This media could be CD-ROMs, for instance. The indexed information, portions thereof and/or the OCR versions of the documents can also be placed on the CD-ROMs if it is so desired. Alternatively, to avoid the problems associated with replacing CD-ROMs when the confidentiality designation of a document changes, the images with overlays could simply be printed and paper copies could be produced. If redesignation of a document is necessary, the document could be reproduced by changing the confidentiality label on the overlay.

Although the preferred embodiments of the present invention have been described and illustrated in detail, it will be evident to those skilled in the art that various modifications and changes may be made thereto without departing from the spirit and scope of the invention as set forth in the appended claims and equivalents thereof.

What is claimed is:

1. A system for secure electronic storage of documents, said system being accessible over an Internet to authorized users, comprising:
a data storage medium, said data storage medium storing said documents;
a document management system, said document management system providing said user with searchable access to said documents stored on said data storage medium; and a
a security system, said security system comprising a password system and encryption system,
said password system requiring said user to enter a password prior to permitting said user to access said documents, and
said encryption system encrypting communications with said user when permitting said user to access said documents.

2. A system as in claim 1, wherein said data storage medium comprises a database.

3. A system as in claim 2, wherein said database comprises a RAID array.

4. A system as in claim 1, wherein said documents are of a plurality of confidentiality levels and said security system denies said user access to a portion of said documents, said portion of said documents being of a confidentiality level said user is unauthorized to see.

5. A system as in claim 4, wherein said documents relate to a litigation.

6. A system as in claim 5, wherein said confidentiality levels are set forth in a court order governing discovery in said litigation.

7. A system as in claim 1, wherein a plurality of computers co-located with said document management service are connected to said document management service, and wherein at least one of said plurality of computers comprises a management computer, said management computer being capable of managing user access to said document management service.

8. A system as in claim 7, wherein at least another of said plurality of computers comprises a document worker workstation, said document worker workstation permitting the creation of indexes of said documents.

9. A process of providing access to electronically stored documents on a documents storage facility via an Internet, comprising the steps of:
providing a website accessible through said Internet;
verifying that a user accessing said website is entitled to access said stored documents;
providing a search screen to said user, said search screen enabling said user to search for terms contained in said stored documents;
searching for said terms in said documents;
displaying results of said search, said displayed results comprising a list, said list identifying documents found to contain said terms during said search and providing hyperlinks thereto;
providing said user with an image of a selected document upon said user selecting one of said documents on said list;
permitting said user to switch views between said image and notes, said notes being related to said selected document;
permitting said user to add information to said notes;
permitting said user to print said selected document.

10. A process of providing access to a stored document as in claim 9, further comprising the step of permitting said user to rotate said image.

11. A process of providing access to a stored document as in claim 9, further comprising the step of permitting said user to magnify said image.

12. A process of providing access to stored documents as claimed in claim 9, wherein said search comprises searching OCR files corresponding to said images.

13. A process of providing access to stored documents as in claim 9, further comprising the step of prohibiting access to a portion of said documents to which said user is not authorized to access.

14. A process of entering documents related to litigation into a computerized document storage facility, said facility being accessible by users from remote locations through an Internet, comprising the steps of:
scanning paper documents into a data storage medium so as to create images of said documents in said data storage medium;
determining if any of said documents fall within a privileged category;
entering information related to said documents in an index;
performing an optical character recognition process on said images so as to create electronically searchable files containing text shown in said documents;
associating each of said images with its respective index entry and electronically searchable file; and
placing said images, said index entries and said electronically searchable files on a storage medium that is accessible to said users over said Internet.

15. A process as in claim 14, wherein said entering step comprises entering objective information.

16. A process as in claim 14, wherein said entering step comprises entering subjective information.

17. A process of producing documents in litigation from an electronic document storage facility accessible from remote locations via an Internet comprising the steps of:
determining which of said documents are to be produced;
storing information identifying said documents to be produced in a file;
transferring said file to a document control system;
selecting overlays to be overlayed on said documents to be produced;
combining images of said documents to be produced and responsive overlays to create overlaid images; and
placing said overlaid images on a memory device.

18. A process as in claim 17, wherein said information relating to said documents to be produced comprises file names of images of said documents to be produced.

19. A process as in claim 17, wherein said memory device comprises a CD-ROM.

20. A process as in claim 17, wherein said memory device comprises paper.

21. A process as in claim 17, wherein said overlays comprise a confidentiality level designation.

22. A process as in claim 17, wherein said overlays comprise a unique identification code separately identifying each page of said documents to be produced.
